(19) United States
(12) Patent Application Publication
(10) Pub. No.: US 2014/0300029 A1
(43) Pub. Date: Oct. 9, 2014

(54) MOLDING ROLLER AND METHOD OF MANUFACTURING SAME

(71) Applicant: HON HAI PRECISION INDUSTRY CO., LTD., New Taipei (TW)

(72) Inventor: CHIA-LING HSU, New Taipei (TW)

(73) Assignee: HON HAI PRECISION INDUSTRY CO., LTD., New Taipei (TW)

(21) Appl. No.: 14/067,949

(22) Filed: Oct. 31, 2013

(30) Foreign Application Priority Data
Apr. 3, 2013 (TW) 102112075

(51) Int. Cl. B29C 33/42

(52) U.S. Cl. CPC B29C 33/424
USPC 264/219; 425/385

(57) ABSTRACT

A molding roller includes a roller body and a molding film. The roller body includes a cylindrical surface. The molding film is coated on the cylindrical surface and includes a molding surface facing away from the cylindrical surface. A micro-structure pattern is formed on the molding surface. The molding film is made of polymer material including polyether-ether-ketone (PEEK).

### BACKGROUND

1. Technical Field

The present disclosure relates to molding devices, and particularly to a molding roller and a method of manufacturing the molding roller.

2. Description of Related Art

Molding rollers generally include a roller body and a copper layer coated on an outer cylindrical surface of the roller body. A micro-structure pattern is formed on the copper layer for molding an optical element, such as a brightness enhancement film. However, when a part of the micro-structure pattern of the copper layer is damaged, the entire copper layer needs to be replaced, which increases a cost of the molding roller.

Therefore, it is desirable to provide a molding roller and a method of manufacturing the molding roller to overcome the limitations described.

### BRIEF DESCRIPTION OF THE DRAWINGS

FIG. 1 is an isometric view of a molding roller in accordance with an exemplary embodiment.

FIG. 2 is a pictural flowchart of a method of manufacturing the molding roller of FIG. 1.

### DETAILED DESCRIPTION

Embodiments of the disclosure will be described with reference to the drawings.

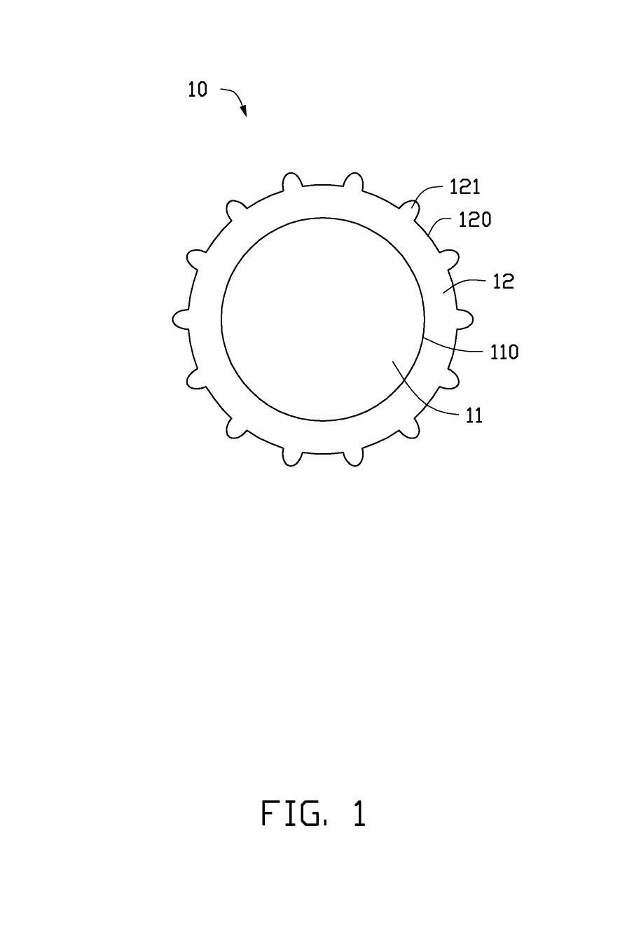

FIG. 1 shows a molding roller 10, which is used to mold an optical element (not shown), such as a brightness enhancement film. The molding roller 10 includes a roller body 11 and a molding film 12 coated on the roller body 11.

The roller body 11 is substantially cylindrical and includes a cylindrical surface 110. The roller body 11 is made of metal, such as copper, and a Mohs hardness of the roller body 11 is greater than about 2.5.

The molding film 12 is coated on the cylindrical surface 110 and forms an annular tube sleeved on the roller body 11. The molding film 12 includes a molding surface 120 facing away from the cylindrical surface 110. A micro-structure pattern 121 is formed on the molding surface 120 for forming the optical element. The molding film 12 is made of a melts of flexible high-polymer material, such as polyether-ether-ketone (PEEK) or a mixture of PEEK, carbon fiber, graphite, and polytetrafluoroethylene (PTFE). A mass of the PEEK is about 70% of the total mass of the mixture. The PEEK gives the molding film 12 a higher strength, lower coefficient of friction, greater machinability, and greater flexibility, which makes the molding film 12 easily separable from the molding optical element and increases a quality of the optical element.

In the embodiment, a thickness of the molding film 12 is substantially uniform. The molding film 12 is formed on the entire cylindrical surface 110. A length of the molding film 12 is substantially equal to a length of the roller body 11. The micro-structure pattern 121 includes a number of protrusions and recesses arranged on the molding surface 120.

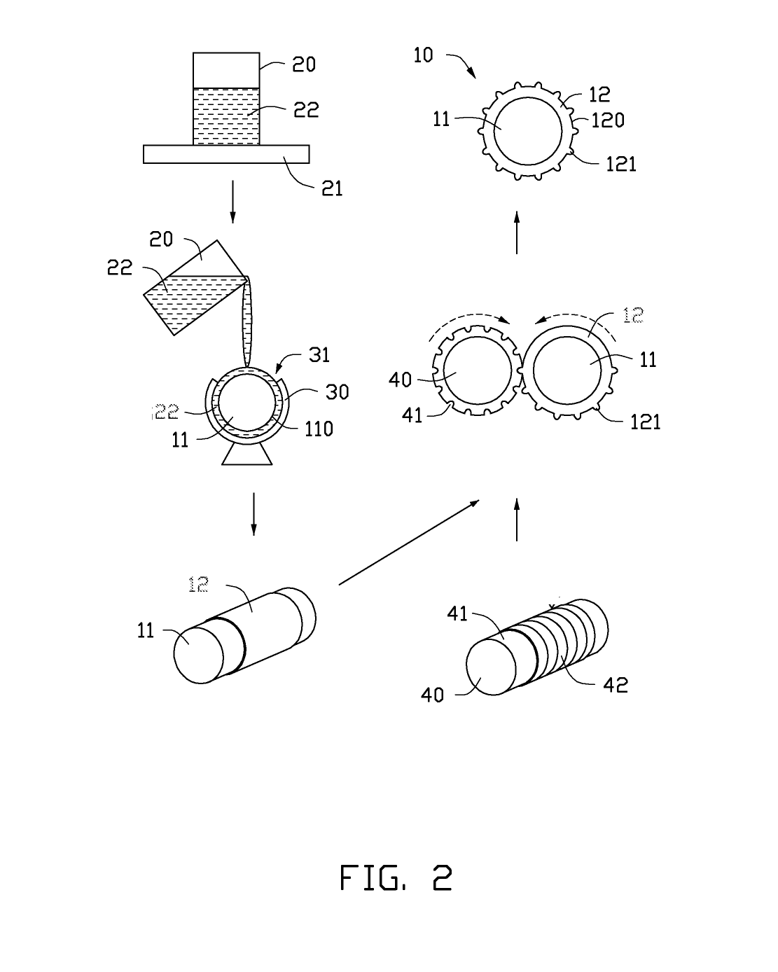

FIG. 2 shows a method of manufacturing the molding roller 10, according to an exemplary embodiment. The method includes steps S101-S106.

S101: a PEEK material 22 is provided and melted. A number of PEEK beads are placed in a receiver 20, and the PEEK beads are melted by a heating device 21 in contact with the receiver 20.

S102: the melted PEEK material 22 is poured on the cylindrical surface 110 of the roller body 11 to form the molding film 12. The roller body 11 is placed in a receiving cavity 31 of a coating device 30, and the melted PEEK material 22 is poured on the roller body 11. As the roller body 11 rotates, the melted PEEK material 22 is coated on the cylindrical surface 110, and the molding film 12 is formed on the roller body 11 as the melted PEEK material 22 is solidified.

In order to improve adhesion between the roller body 11 and the molding film 12, the cylindrical surface 110 is roughened by sandblasting before the molding film 12 is formed on the roller body 11.

S103: the molding film 12 is ground. When the molding film 12 is cooled to room temperature, a thickness of the molding film 12 will not be uniform. The molding film 12 is ground by a grinder (not shown) to make the molding film 12 have a uniform thickness throughout.

It should be understood that if the thickness of the molding film 12 formed on the roller body 11 in step S102 is uniform, step S103 can be omitted.

S104: a metal roller 40 having a transfer printing surface 41 is provided. The transfer printing surface 41 includes a transfer printing pattern 42. The transfer printing pattern 42 is formed on the transfer printing surface 41 by an etching or carving process. In this embodiment, the metal roller 40 is made of copper.

S105: the metal roller 40 is rolled over the molding film 12 to transfer the transfer printing pattern 42 onto the molding film 12. The metal roller 40 is rolled once over the molding film 12 after the molding film 12 is heated to about 300 and the metal roller 40 is heated to about 170. A pressure of the metal roller 40 applied on the molding film 12 is constant.

S106: the micro-structure pattern 121 of the molding roller 10 is solidified.

In the embodiment, since the micro-structure pattern 121 is transferred onto the molding film 12, the manufacturing process of the molding roller 10 is simplified.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A molding roller, comprising:
a roller body comprising a cylindrical surface; and
a molding film coated on the cylindrical surface, and comprising a molding surface facing away from the cylindrical surface and a micro-structure pattern formed on the molding surface;
wherein the molding film is made of polymer material comprising polyether-ether-ketone (PEEK).

2. The molding roller of claim 1, wherein the polymer material further comprises carbon fiber, graphite, and polytetrafluoroethylene (PTFE).

3. The molding roller of claim 2, wherein a mass of the PEEK is about 70% of the total mass of the polymer material.

4. The molding roller of claim 1, wherein a thickness of the molding film is uniform.

5. The molding roller of claim 1, wherein the molding film is formed on the entire cylindrical surface, and a length of the molding film is substantially equal to a length of the roller body.

6. A method of manufacturing a molding roller, comprising:
providing a melted polyether-ether-ketone (PEEK) material;
coating the melted PEEK material on a cylindrical surface of a roller body to form a molding film;
providing a metal roller having a transfer printing surface, the transfer printing surface comprising a transfer printing pattern;
transferring the transfer printing pattern of the metal roller on the molding film to form a micro-structure pattern; and
solidifying the micro-structure pattern.

7. The method of claim 6, wherein the cylindrical surface is roughened by sandblasting before the molding film is formed on the roller body.

8. The method of claim 6, wherein the molding film is heated to 300 and the metal roller is heated to 170 during transferring the micro-structure pattern.

9. The method of claim 6, wherein the micro-structure pattern corresponding to the transfer printing pattern is formed on the molding film.

10. The method of claim 6, wherein the molding film is ground before forming the micro-structure pattern.
